(19) United States
(12) Patent Application Publication
(10) Pub. No.: US 2013/0155695 A1
(43) Pub. Date: Jun. 20, 2013

(54) LED LAMP

(71) Applicant: TAY-JIAN LIU, Tu-Cheng (TW)

(72) Inventor: TAY-JIAN LIU, Tu-Cheng (TW)

(73) Assignee: FOXCONN TECHNOLOGY CO., LTD., Tu-Cheng (TW)

(21) Appl. No.: 13/491,610

(22) Filed: Jun. 8, 2012

(30) Foreign Application Priority Data
Dec. 20, 2011 (CN) 201110429354.4

(51) Int. Cl. F21V 29/00; F21V 31/00

(52) U.S. Cl. 362/373

(57) ABSTRACT

An LED lamp includes an optical portion, a heat dissipation portion, and an electrical portion. The optical portion includes a base, an LED formed on the base, and an upper housing covering the LED. The heat dissipation portion includes a tube and a lower housing formed around the tube, which cooperatively define a chamber therebetween. A coolant is filled in the chamber. An upper end of the tube is sealed by the base, whereas a lamp connector is formed at a lower end of the tube. A circuit board attached with heat-generating electrical components is positioned inside the tube. A thermally conductive glue is injected into the tube. During operation of the LED lamp the coolant experiences a phase change to absorb heat generated by the LED and the circuit board and its electrical components.

### BACKGROUND

1. Technical Field

The present disclosure relates to an LED (light emitting diode) lamp, and particularly to an LED lamp with relatively high heat dissipating efficiency.

2. Description of Related Art

In recent years, LED lamps are widely used to replace CCFLs (cold cathode fluorescent lamps) and other traditional lamps due to their excellent properties, including high brightness, long lifespan, directivity, and etc.

For an LED lamp, a heat dissipation device is necessary for timely and adequately removing the heat generated by the LEDs. Generally, people pay much attention to a heat dissipation of the LEDs but ignore a heat dissipation of the circuit board. When the circuit board is overheating, electronic components in the circuit board will be out of work, therefore affecting the lifespan and stability of the LED lamp.

For the foregoing reasons, therefore, there is a need in the art for an LED lamp which overcomes the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, cross-sectional view of an LED lamp in accordance with a first embodiment of the present disclosure.

FIG. 2 is a view similar to FIG. 1, showing a light engine of the LED lamp thereof.

FIG. 3 is a schematic, front side view of a light source in accordance with a second embodiment of the present disclosure.

FIG. 4 is a schematic, front side view of a light source in accordance with still a third embodiment of the present disclosure.

### DETAILED DESCRIPTION

Reference will now be made to the drawing figures to describe the various embodiments in detail.

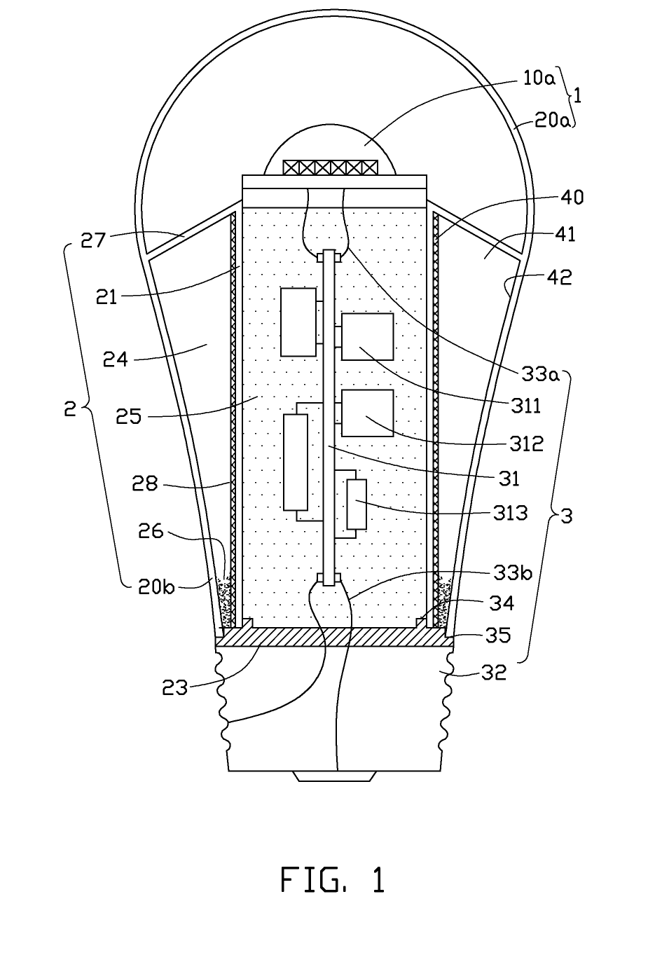

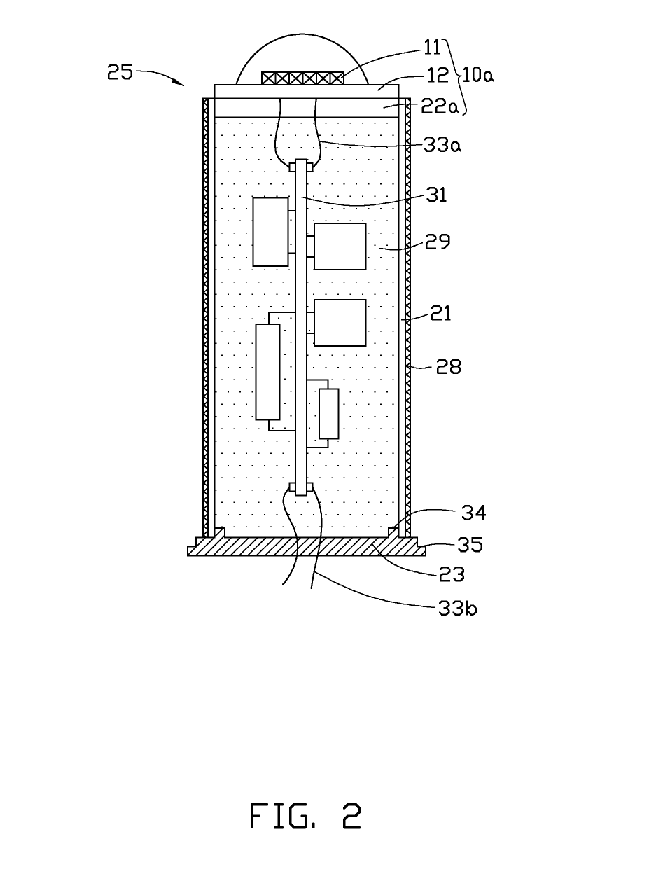

Referring to FIGS. 1-2, an LED lamp according to a first embodiment is provided. The LED lamp is in a form of a light bulb, which includes an optical portion 1, a heat dissipation portion 2 and an electrical portion 3.

The optical portion 1 is positioned at a top of the heat dissipation portion 2 and the electrical portion 3. The optical portion 1 includes a light source 10a and a transparent upper housing 20a covering and protecting the light source 10a. The light source 10a includes a substrate 12 and at least one LED 11 arranged on the substrate 12. The substrate 12 is made of a material with relatively high heat dissipation efficiency, such as a metal printed circuit board (metal PCB). The LED 11 is formed by an LED chip encapsulated by a transparent material. Preferably, a thermal interface material (TIM) is formed between the substrate 12 and the heat dissipation portion 2 to enhance heat conductive efficiency therebetween.

The heat dissipation portion 2 includes a tube 21 and a lower housing 20b. The lower housing 20b may be integrally formed with the upper housing 20a as a single piece or formed separately and then connected thereto. The tube 21 is formed at a lower side of the optical portion 1. The lower housing 20b surrounds the tube 21 and defines a chamber 24 between the lower housing 20b and the tube 21. An upper end of the tube 21 is sealed by a base 22a, which is made of thermally conducting material. A lower end of the tube 21 is sealed by a bottom plate 23, which is made of electrically insulating material. A diameter of the bottom plate 23 is larger than that of the tube 21; therefore, a peripheral part of the bottom plate 23 protrudes radially out from a periphery of the tube 21. The bottom plate 23 defines an annular groove 35 in a top of the peripheral part thereof to securely receive a lower end of the lower housing 20b therein. An annular protrusion 34 is formed on an upper surface of the bottom plate 23 and engages with an inner surface of the tube 21 to secure the tube 21 to the bottom plate 23. A capillary wick 28 is attached to an outer surface of the tube 21. Particularly, the capillary wick 28 can be selected from one or more from a group consisting of fine grooves defined in the outer surface of the tube 21, screen mesh or fiber inserted into the chamber 24 and attached to the outer surface of the tube 21, or sintered powder bonded to the outer surface of the tube 21 by a sintering process. A size of the chamber 24 gradually increases from a bottom end to an upper end thereof. The lower housing 20b, the tube 21 and the bottom plate 23 are connected intimately and firmly to seal the bottom end of the chamber 24. An annular partition 27 is located at the upper end of the chamber 24. An inner edge of the partition 27 is firmly connected with the outer surface of the tube 21, and an outer edge of the partition 27 is firmly connected with the lower housing 20b, thereby hermetically separating the optical portion 1 from the heat dissipation portion 2. In other words, vapor generated in the chamber 24 during operation of the LED lamp is blocked by the partition 27 from entering the optical portion 1. The chamber 24 is filled with a coolant 26, to enhance heat transfer properties of the heat dissipation portion 2. In addition, the chamber 24 can also be vacuumized to facilitate the vaporization of the coolant 26 to obtain a better heat dissipation.

The electrical portion 3 is configured to provide a driving circuit and a power management for the light source 10a. The electrical portion 3 includes a lamp connector 32 and a circuit board 31. Electrical components which can generate heat during operation thereof are mounted on the circuit board 31. These electrical components can include, for example, a rectifier 311, a capacitor 312 and a resistor 313. The lamp connector 32 is positioned at a bottom end of the light source 10a, and is used to be threadedly inserted into a lamp holder (not shown) to provide power for the light source 10a. The lamp connector 32 can be a standard screw connector such as an E27 base for an incandescent lamp. The circuit board 31 is positioned inside the tube 21. The circuit board 31 is electrically connected with the light source 10a through wires 33a, and electrically connected with the lamp connector 32 through wires 33b. Electrically insulating glue 29 is filled in the tube 21 thereby securing the circuit board 31 inside the tube 21. The glue 29 has relatively high thermal conductive efficiency; therefore, heat generated from the circuit board 31 and the electrical components 311, 312, 313 can be conducted to the tube 21 efficiently.

When the LED lamp emits light, heat generated from the light source 10a is conducted to the tube 21 through the base 22a, and heat generated from the circuit board 31 and its electrical components 311, 312, 313 is conducted to the tube 21 through the heat conductive glue 29 inside the tube 21. The outer surface of the tube 21 is attached with the capillary wick 28 and formed an evaporating section 40, and the coolant 26 in the capillary wick 28 absorbs the heat in the tube 21 and vaporizes at a saturation temperature. The vaporized coolant 26 with high enthalpy latent heat quickly expands and fills in the chamber 24 to form an annular vapor channel 41 with rather lower flow resistance. The lower housing 20b forms a condensing section 42 in an inner surface thereof. The vaporized coolant 26 flows through the chamber 24 to the condensing section 42, dissipates the latent heat through the lower housing 20b to a surrounding environment and is condensed to the liquid coolant 26 again at the saturating temperature. The condensed liquid coolant 26 in the condensing section 42 falls into the bottom of the chamber 24 by gravity and is absorbed by the capillary wick 28 again. In the falling process, the liquid coolant 26 keeps dissipating sensible heat to the lower housing 20b and becomes a subcooled liquid coolant 26 with a temperature lower than the saturating temperature. The subcooled liquid coolant 26 is absorbed by the capillary wick 28 and through the outer surface of the tube 21 to absorb the heat from the light source 10a and the circuit board 31 and the electrical components 311, 312, 313 again, thereby to conduct circulation of the latent and sensible heat dissipation.

In the LED lamp of present disclosure, the phase change of the coolant 26 inside the chamber 24 can effectively transfer the generated heat from the light source 10a and the circuit board 31 and its electrical components 311, 312, 313 to the lower housing 20b, and then the lower housing 20b will dissipate the heat into ambient environment. Therefore, the chamber 24 maintains in a low temperature with nearly a zero temperature gradient, thereby to make sure the LED lamp have a high light efficiency, a low light attenuation, a stable and long lifespan.

In this embodiment, the upper housing 20a, the lower housing 20b, the tube 21, the bottom plate 23 and the partition 27 can be made of glass or polycarbonate to obtain a better connection between them by a glass bonding technology or an adhesive bonding technology. The transparent glass or the polycarbonate can also allow light from the light source 10a emitting in all directions; therefore, a wide light distribution of the LED lamp is obtained. Furthermore, an appearance of an incandescent lamp can be obtained when the upper and lower housings 20a, 20b are made of transparent material. Alternatively, the tube 21 can also be made of metals or porous sintered materials to enhance heat dissipation efficiency. When the tube 21 is made of porous sintered materials, the capillary wick 28 around the tube 21 is omitted because the tube 21 itself can provide a capillary force for the liquid coolant 26.

The coolant 26 is made of a liquid with low boiling point, high latent heat and easy to vaporize, such as alcohol, refrigerant or pure water. The vacuum chamber 24 can make the coolant 26 generate phase change in a relatively low temperature. Therefore, heat from the light source 10a and the circuit board 31 and its electrical components 311, 312, 313 can effectively be dissipated into the environment, thereby to make the LED lamp work in a low and uniform temperature.

In assembling of the LED lamp, the substrate 12 is located at a top side of the base 22a, and the bottom side of the base 22a is embedded in the upper end of the tube 21 and hermetically seals the upper end. Then, the capillary wick 28 is formed around the tube 21. Before putting the circuit board 31 into the tube 21, the wires 33a for connecting the substrate 12 and the wires 33b for connecting the lamp connector 32 are firstly soldered to the circuit board 31. When the circuit board 31 is positioned inside the tube 21, the wires 33a extend through holes predetermined in the base 22a to electrically connect with the substrate 12 and the wires 33b extend through holes predetermined in the bottom plate 23 to electrically connect with the lamp connector 32. The bottom plate 23 is secured to and hermetically seals the bottom end of the tube 21. The annular protrusion 34 of the bottom plate 23 is inserted into the bottom end of the tube 21 and securely engages with the inner surface of the tube 21 for securing the tube 21 to a predetermined position of the bottom plate 23. After the two ends of the tube 21 are sealed respectively by the base 22a and the bottom plate 23, the tube 21 is filled up with the electrically insulating and heat conductive glue 29 through holes in the bottom plate 23. The glue 29 is then solidified to make the light source 10a, the circuit board 31 and the tube 21 with the capillary wick 28 connect together as a whole to form a light engine 25. After that, the light engine 25 is assembled to the lower housing 20b until the bottom end of the housing 20b is inserted into the annular groove 35 at the flange of the bottom plate 23. The inner edge of the annular partition 27 is hermetically secured to the upper end of the tube 21. The outer edge of the annular partition 27 is hermetically secured to the upper end of the lower housing 20b; therefore, the chamber 24 is formed between the tube 21 and the lower housing 20b. The partition 27 has predetermined holes for injecting the coolant 26 into the chamber 24. The chamber 24 can also be vacuumized by the holes. After the coolant 26 is injected into the chamber 24 and the chamber 24 is vacuumized, the holes are sealed. Then, the wires 33b extending through the bottom plate 23 are soldered to the lamp connector 32 and the lamp connector 32 is secured to a bottom side of the bottom plate 23, whereby the lamp connector 32 is secured at the bottom end of the lower housing 20b. In this embodiment, the wires 33b can be made of copper wires coated with an electrically insulating paint thereon to electrically insulate the copper wires 33b from each other. Finally, the upper housing 20a covers the light source 10a and connects with the lower housing 20b.

In the assembling process described above, the light engine 25, the lower housing 20b and the lamp connector 32 are connected together through the bottom plate 23 which is made of electrically insulating material. The protrusion 34 of the bottom plate 23 is for securing the tube 21, and the groove 35 of the bottom plate 23 is for securing the lower housing 20b. Furthermore, the bottom plate 23 is made of electrically insulating material such that the lower housing 20b and the tube 21 can be made of metal to increase heat dissipation efficiency of the LED lamp. Especially, when the tube 21 is made of sintered metal powder, the capillary wick 28 around the tube 21 can be omitted. Besides, the tube 21 made of sintered metal powder can provide a stronger capillary force for the coolant 26; therefore, the heat dissipation efficiency of the LED lamp can be increased and the light output efficiency for the light sources 10a can be enhanced.

The LED lamp as described above has a high heat dissipating efficiency. By connecting the light source 10a, the circuit board 31 and the tube 21 as a whole to form the light engine 25, the heat generated from the light source 10a and the circuit board 31 can be effectively conducted to the coolant 26 in the capillary wick 28. Through the evaporation and condensation phase change process of the coolant 26 in the chamber 24, the heat can be effectively dissipated into the environment by a latent heat exchange mechanism. Because the heat transfer coefficient of the latent heat exchange mechanism is more than 100 to 1000 times higher than that of the pure liquid cooling and more than 10000 times higher than that of the air cooling. The mechanism can provide zero temperature gradient. Therefore, the LED lamp can be lighten and keep working in an uniform low temperature. By connecting the base 22a with the tube 21 and forming the chamber 24 around the tube 21, the manufacture of the LED lamp is simplified.

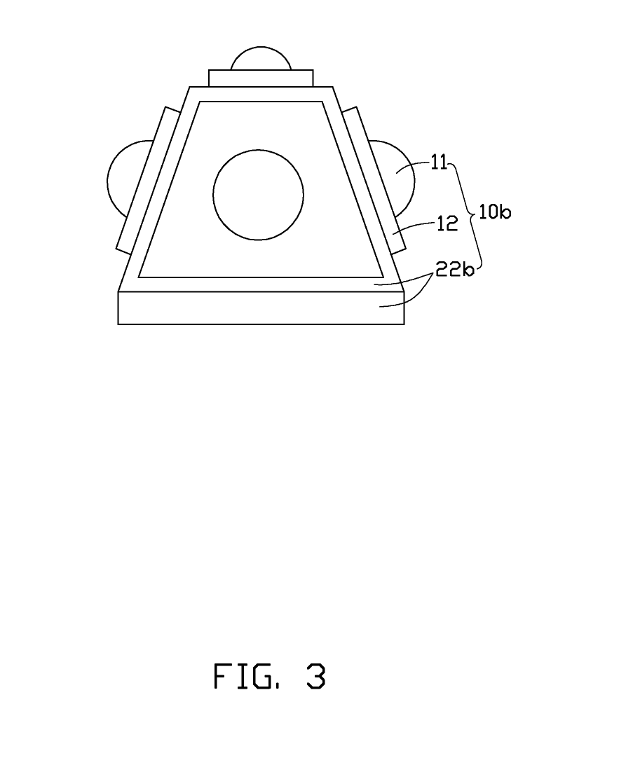

Referring to FIG. 3, a light source 10b according to another embodiment is provided. The light source 10b includes a base 22b. The base 22b is a frustum of a square pyramid, which includes an upper surface and four lateral surfaces inclined to the upper surface. The upper surface and the four lateral surfaces are attached with a substrate 12 respectively. An LED 11 is arranged on each of the substrate 12. The bottom end of the base 22b has a same shape with the base 22a as described above to be embedded in the top end of the tube 21. Heat generated from the light source 10b is absorbed by the base 22b and transferred to the tube 21. The phase change of the coolant 26 in the chamber 24 will absorb the heat in the tube 21, thereby to make the LED lamp work in a low temperature. Alternatively, the base 22b can also be polyhedrons with other shape such as pyramid and prism.

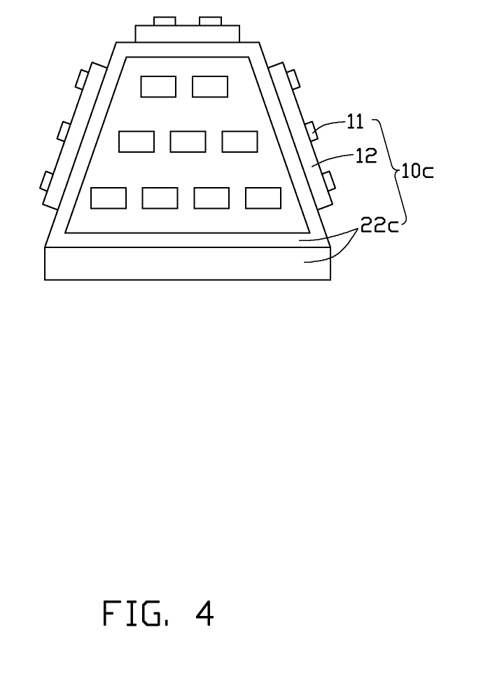

Referring to FIG. 4, a light source 10c according to still another embodiment is provided. The light source 10c includes a base 22c. The base 22c is a frustum of a square pyramid, which includes an upper surface and four lateral surfaces inclined to the upper surface. The upper surface and the four lateral surfaces are attached with a substrate 12 respectively. Different from the light source 10b in FIG. 3, a plurality of LEDs 11 is arranged on each of the substrate 12. The bottom end of the base 22c has a same shape with the base 22a to be embedded in the upper end of the tube 21. Therefore, the heat from the light source 10c can be effectively transferred to the tube 21 and absorbed by the phase change of the coolant 26. Alternatively, the base 22c can also be polyhedrons with other shape such as pyramid and prism.

The LED lamp as described above, the light sources 10b and 10c include bases of polyhedrons. The surfaces of the bases are oriented to the upper housing 20a along different directions and each of the surfaces is attached with at least one LED 11. Therefore, the light sources 10b and 10c will emit light in a wide angle.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An LED lamp, comprising:
an optical portion comprising a base, a light source formed on the base, and an upper housing covering the light source;
a heat dissipation portion comprising a tube and a lower housing formed around the tube, the lower housing and the tube defining a hermetically sealed chamber around the tube, one end of the tube being sealed by the base;
a coolant filled in the chamber; and
an electrical portion comprising a lamp connector formed at another end of the tube and configured for connecting with both an external power source and a circuit board mounted with heat-generating electrical components positioned inside the tube to provide a driving circuit and a power management for the light source, an electrically insulating and thermally conductive glue being filled up with the tube to enhance heat dissipation efficiency and to secure the circuit board.

2. The LED lamp of claim 1, wherein the upper housing and the lower housing are made of glass or polycarbonate, the upper housing and the lower housing are coupled with each other, therefore forming an appearance as an incandescent lamp.

3. The LED lamp of claim 1, wherein the tube is made of glass or polycarbonate.

4. The LED lamp of claim 1, wherein the tube is made of metal.

5. The LED lamp of claim 1, wherein the tube is made of porous sintered material.

6. The LED lamp of claim 3, wherein a capillary wick is formed around the tube.

7. The LED lamp of claim 6, wherein the capillary wick can be selected from one or more from a group consisting of a wick with multi-layer metal nettings, a wick with sintering metal powder, and a wick with micro-grooves formed on a periphery of the tube.

8. The LED lamp of claim 1, wherein a bottom plate is secured to and seals a bottom end of the tube, a diameter of the bottom plate is larger than that of the tube therefore a peripheral part of the bottom plate protrudes radially out of the tube.

9. The LED lamp of claim 8, wherein a protrusion is formed at an upper surface of the bottom plate, the protrusion is inserted into the bottom end of the tube to engage with the tube thereby to secure the tube to the bottom plate.

10. The LED lamp of claim 9, wherein an annular groove is formed at the peripheral part of the bottom plate, a bottom end of the lower housing is inserted into the groove to thereby secure the lower housing to the bottom plate.

11. The LED lamp of claim 10, wherein the bottom plate is made of an electrically insulating material.

12. The LED lamp of claim 1, wherein the coolant is selected from a group consisting of alcohol, refrigerant and pure water.

13. The LED lamp of claim 1, wherein the base has a shape of frustum of a square pyramid, which comprise an upper surface and four lateral surfaces inclined to the upper surface, each of the upper surface and the four lateral surfaces is attached with a substrate, each of the substrates is attached with at least one LED.

14. The LED lamp of claim 1, wherein the base has a shape of pyramid or prism.

15. The LED lamp of claim 13, wherein the base has a bottom end to be embedded into and seal the one end of the tube.

16. The LED lamp of claim 1, wherein a bottom end of the chamber is sealed by a bottom plate connected with a bottom end of the lower housing and a bottom end of the tube, an upper end of the chamber is sealed by an annular partition, an inner edge of the partition is firmly connected with the tube and an outer edge of the partition is firmly connected with the lower housing thereby hermetically separating the optical portion from the heat dissipation portion.

17. The LED lamp of claim 1, wherein the chamber is vacuumized.
